(19) United States
(12) Patent Application Publication
(10) Pub. No.: US 2003/0152150 A1
(43) Pub. Date: Aug. 14, 2003

(54) Information processing apparatus and method, recording medium, and program

(76) Inventors: Yuji Fujimoto, Kanagawa (JP); Satoshi Mitsuhashi, Tokyo (JP)

Correspondence Address: William S. Frommer, Esq., FROMMER LAWRENCE & HAUG LLP, 745 Fifth Avenue, New York, NY, 10151, US

(21) Appl. No.: 10/336,961

(22) Filed: Jan. 6, 2003

(30) Foreign Application Priority Data
Jan. 8, 2002 (JP) 2002-001290

(51) Int. Cl. H04N 11/04; H04N 11/02; H04N 7/12; H04B 1/66

(52) U.S. Cl. 375/240.24; 375/240.2

(57) ABSTRACT

The pixel values of a current macroblock are summed, and the pixel values of a reference macroblock are summed. The initial minimum sum of absolute differences between the current and reference macroblocks is determined. When the minimum sum of absolute differences is greater than the absolute difference between the summed pixel values in the current macroblock and the reference macroblock, the sum of absolute differences between the current macroblock and the reference macroblock is calculated. When the sum of absolute differences is smaller than the minimum sum of absolute differences, the value of the sum of absolute differences is set as the minimum sum of absolute differences. If all blocks of a search area have not been searched, the pixel values of a new reference macroblock are summed. When all blocks of the search area have been searched, the block type is determined and the motion vector is output.

### BACKGROUND OF THE INVENTION

1. Field of the Invention

The present invention relates to an information processing apparatus and method, a recording medium, and a program. In particular, the present invention relates to an information processing apparatus and method, recording medium, and program suitable for compressing moving image data using MPEG.

2. Description of the Related Art

A technique called MPEG (Moving Picture Experts Group) is widely used for compressing digital moving image data. The MPEG compression technique supports video data compression and audio data compression. The MPEG compression technique employs compression methods including DCT (Discrete Cosine Transform), motion prediction, and inter-frame encoding for increasing the compression efficiency. When digital moving image data is compressed using MPEG, basically, the differences between frames of the moving image data are recorded such that, based on the first frame, a portion of the second frame which is different from the first frame, a portion of the third frame which is different from the second frame, and so on are recorded, thereby achieving data compression.

MPEG-1 for use in video-CDs etc., is standardized based on ITU-T (ITU (International Telecommunication Union) Telecommunication Standardization Sector) Recommendation H.261 which is a moving picture compression standard specified mainly by telecommunication service providers. In MPEG-1, data is compressed by predicting the moving direction of an object in an image, whose vector alone is then stored. The MPEG-1 technique is designed for data storage or reproduction on a storage medium such as a CD-ROM (compact disk read-only memory), and the reproduction quality is as high as VTR reproduction quality. Another standard called MPEG-2 is designed for use in broadcasting media, and the reproduction quality is as high as HDTV reproduction quality.

MPEG-4 is a video encoding technique at the rate from 10 kbps to 2 Mbps. The compression method employed in MPEG-4 is implemented by the same basic technique as MPEG-1 and MPEG-2. However, while MPEG-1 and MPEG-2 employ decomposition of only a changing portion in a key frame image, MPEG-4 employs decomposition of images of frames into objects (that is, in MPEG-4, elements forming an image are decomposed into, for example, a background, a person, a building, and the like) to record the differences based on each of the objects.

MPEG-4 encoding involves motion search in which an n×n pixel block including a VOP (Video Object Plane) to be coded is matched with a reference image in a search area to determine the sum of absolute differences AD between pixels in the block and the reference image to detect, as motion vector MV, the amount of movement when the sum of absolute differences AD is minimum. Concurrently with motion compensation for each macroblock, the mode information of each macroblock (including information indicating whether or not the macroblock belongs to the VOP, whether or not application of motion compensation is possible, and so on) is determined. The macroblocks are then re-sized. In motion compensation of shape information, both motion vector MV obtained from the shape information itself and normal motion vector MV obtained from texture information are taken into account.

The above-described motion search processing is the most time-consuming not only in the MPEG-4 algorithm but in any MPEG algorithm. Therefore, fast motion search or reduction of the processing amount is essential for real-time video encoding in, for example, MPEG-4.

### SUMMARY OF THE INVENTION

Accordingly, it is an object of the present invention to reduce the number of computations needed for MPEG-based video compression.

In an aspect of the present invention, an information processing apparatus includes an extracting unit, a first calculating unit, a first setting unit, a first comparing unit, a second calculating unit, and a second setting unit. The extracting unit extracts at least one second block which is a reference block with respect to a first block formed of a predetermined number of pixels in the image data. The first calculating unit calculates a first value which is the absolute difference between the sum of the pixels of the first block and the sum of the pixels of the second block extracted by the extracting unit. The first setting unit sets the initial value of a second value which is compared to the first value determined by the first calculating unit. The first comparing unit compares the first value determined by the first calculating unit with the second value. When it is determined by the first comparing unit that the first value is smaller than the second value, the second calculating unit calculates a third value which is the sum of absolute differences between the pixels of the first block and the pixels of the second block. When the third value determined by the second calculating unit is smaller than the second value, the second setting unit sets the third value as the second value. The extracting unit sequentially extracts all the second blocks in a predetermined search area.

The extracting unit may move the extracted target in the second blocks within the search area in a spiral manner around the first block.

The first setting unit may set the initial value of the second value to smaller one of a first threshold for determining whether or not motion compensation is performed and a second threshold for determining whether or not the first block contains a reference block.

The information processing apparatus may further include an output unit for outputting a result of determination of the block type of the first block using the second value after processing performed on all the second blocks extracted by the extracting unit is completed, or a result of calculation of a motion vector used to encode the first block.

In another aspect of the present invention, an information processing method includes an extracting step of extracting at least one second block, the second block being a reference block with respect to a first block formed of a predetermined number of pixels in the image data; a first calculating step of calculating a first value which is the absolute difference between the sum of the pixels of the first block and the sum of the pixels of the second block extracted in the extracting step; a first setting step of setting the initial value of a second value which is compared to the first value determined in the first calculating step; a first comparing step of comparing the first value determined in the first calculating step with the second value; a second calculating step of calculating a third value which is the sum of absolute differences between the pixels of the first block and the pixels of the second block when it is determined in the first comparing step that the first value is smaller than the second value; and a second setting step of setting the third value as the second value when the third value determined in the second calculating step is smaller than the second value. In the extracting step, all the second blocks in a predetermined search area are sequentially extracted.

In still another aspect of the present invention, a recording medium has a program recorded therein. The program includes an extracting step of extracting at least one second block, the second block being a reference block with respect to a first block formed of a predetermined number of pixels in the image data; a first calculating step of calculating a first value which is the absolute difference between the sum of the pixels of the first block and the sum of the pixels of the second block extracted in the extracting step; a first setting step of setting the initial value of a second value which is compared to the first value determined in the first calculating step; a first comparing step of comparing the first value determined in the first calculating step with the second value; a second calculating step of calculating a third value which is the sum of absolute differences between the pixels of the first block and the pixels of the second block when it is determined in the first comparing step that the first value is smaller than the second value; and a second setting step of setting the third value as the second value when the third value determined in the second calculating step is smaller than the second value. In the extracting step, all the second blocks in a predetermined search area are sequentially extracted.

In still another aspect of the present invention, a program includes an extracting step of extracting at least one second block, the second block being a reference block with respect to a first block formed of a predetermined number of pixels in the image data; a first calculating step of calculating a first value which is the absolute difference between the sum of the pixels of the first block and the sum of the pixels of the second block extracted in the extracting step; a first setting step of setting the initial value of a second value which is compared to the first value determined in the first calculating step; a first comparing step of comparing the first value determined in the first calculating step with the second value; a second calculating step of calculating a third value which is the sum of absolute differences between the pixels of the first block and the pixels of the second block when it is determined in the first comparing step that the first value is smaller than the second value; and a second setting step of setting the third value as the second value when the third value determined in the second calculating step is smaller than the second value. In the extracting step, all the second blocks in a predetermined search area are sequentially extracted.

According to the present invention, therefore, at least one second block which is a reference block with respect to a first block formed of a predetermined number of pixels in image data is extracted; a first value which is the absolute difference between the sum of the pixels of the first block and the sum of the pixels of the second block is calculated; the initial value of a second value which is compared to the first value is set; the first value is compared with the second value; when it is determined that the first value is smaller than the second value, a third value which is the sum of absolute differences between the pixels of the first block and the pixels of the second block is calculated; when the third value is smaller than the second value, the third value is set as the second value; and all the second blocks in a predetermined search area are sequentially extracted.

Accordingly, when moving image data is compressed using MPEG, the number of computations needed for motion search can be reduced.

### BRIEF DESCRIPTION OF THE DRAWINGS

FIG. 1 is a block diagram of a personal computer;

FIG. 2 is an illustration of a macroblock, a search area, and a motion vector;

FIG. 3 is a flowchart showing a motion search process according to the present invention;

FIG. 4 is a diagram for illustrating the motion search process in which an image is spirally searched;

FIG. 5 is a flowchart showing an initial MinAD calculation process in step S3 of the flowchart shown in FIG. 3; and

FIG. 6 is a flowchart showing a block type determining and motion vector outputting process in step S10 of the flowchart shown in FIG. 3.

### DESCRIPTION OF THE PREFERRED EMBODIMENTS

An embodiment of the present invention is described below with reference to the drawings.

A personal computer capable of transmitting and receiving information over a network such as the Internet or a telephone line network compresses moving image data stored therein using, for example, MPEG-4, and transmits the compressed data to other devices such as portable telephone sets, PDAs (personal digital assistants), and other personal computers.

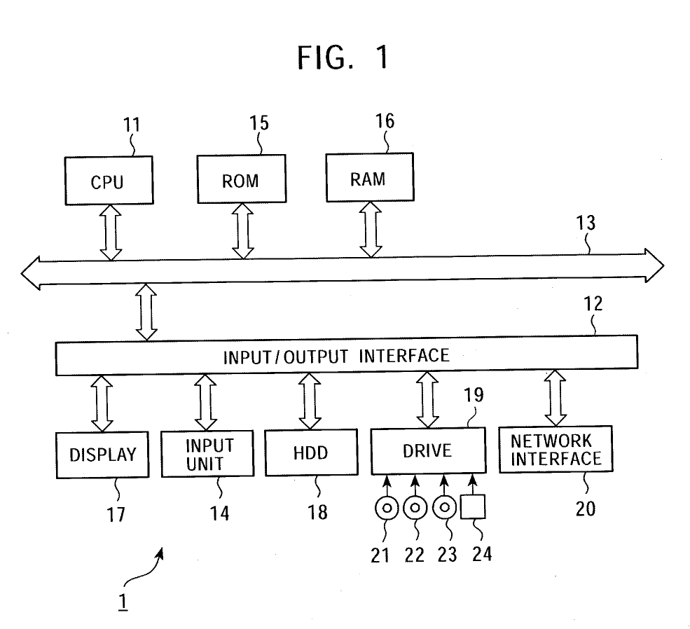

FIG. 1 is a block diagram of the configuration of a personal computer 1.

A CPU (central processing unit) 11 receives via an input/output interface 12 and an internal bus 13 signals corresponding to various instructions input by a user using an input unit 14, and signals input from other devices via a network interface 20. The CPU 11 executes various processings based on the input signals. A ROM (read only memory) 15 basically stores fixed data out of programs and computational parameters used by the CPU 11. A RAM (random access memory) 16 stores the programs executed by the CPU 11 and parameters which appropriately change during execution of the programs. The CPU 11, the ROM 15, and the RAM 16 are connected with one another via the internal bus 13.

The internal bus 13 is also connected with the input/output interface 12. The input unit 14 includes a keyboard, a touch pad, a jog dial, and a mouse, and is operated by a user to input various instructions to the CPU 11. A display 17, such as a CRT (cathode-ray tube) or a liquid crystal display, displays various information in the form of text, image, or the like.

An HDD (hard disk drive) 18 drives a hard disk to record or play back the programs executed by CPU 11 or information. A magnetic disk 21, an optical disk 22, a magneto-optical disk 23, or a semiconductor memory 24 is attached to a drive 19, as required, to exchange data.

The network interface 20 is connected to a network or other devices so as to communicate information.

The input unit 14, the display 17, the HDD 18, the drive 19, and the network interface 20 are connected to the CPU 11 via the input/output interface 12 and the internal bus 13.

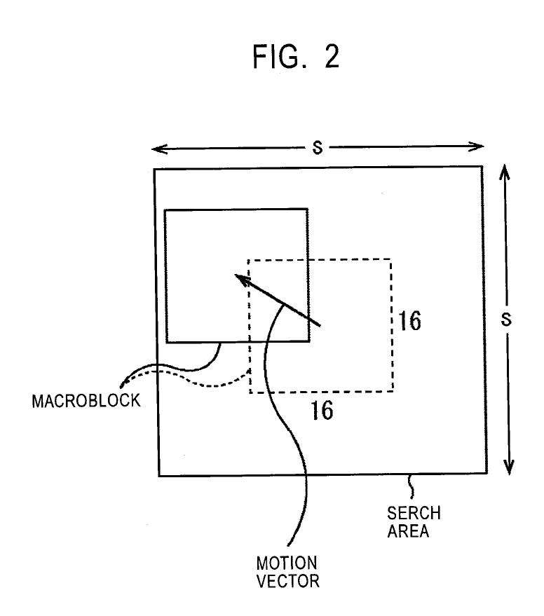

When a moving image stored in the HDD 18 is encoded with, for example, MPEG-4, the CPU 11 performs MPEG-4 motion search processing in which, as shown in FIG. 2, an input image (current image) is divided into macroblocks (MBs) each of which is a block of 16×16 pixels and the matching position of a macroblock of a reference image is moved in a specified search area (an area of s×s pixels, in this example) with respect to the current image, followed by calculation of the following equation (1) to determine the sum of absolute differences AD between pixels in the current macroblock and the reference macroblock:

AD=Σ|r(i, j)−c(i, j)| (1)

where c(i,j) indicates the pixel value of a pixel (i,j) in the current macroblock, r(i,j) indicates the pixel value of a pixel (i,j) in the reference macroblock.

The CPU 11 determines, as a motion vector, the relative position in which the sum of absolute differences AD is minimized in the search area.

In a typical motion search process, the absolute differences from all reference macroblocks are calculated to determine the minimum sum of absolute differences MinAD. In the present invention, on the other hand, the inequality relation in expression (2) is used to determine the sum of absolute differences AD using equation (1) only when expression (3) holds true in order to reduce the number of computations performed by equation (1):

Σ|r(i, j)−c(i, j)|≧|Σr(i, j)−Σc(i, j)| (2)

|Σr(i, j)−Σc(i, j)|<MinAD (3)

where MinAD indicates the minimum of the sum of absolute differences AD updated during a motion search process described below.

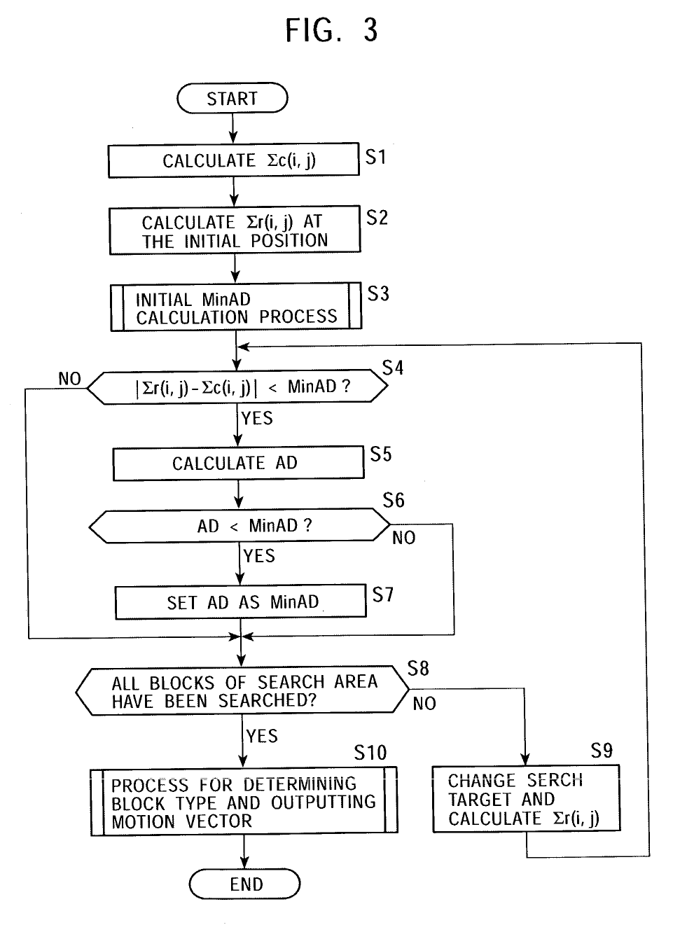

The motion search process according to the present invention is now described with reference to the flowchart shown in FIG. 3.

In the motion search process shown in FIG. 3, it is assumed that moving image data recorded in advance in the HDD 18 or moving image data which is input from an external device via the network interface 20 or the like and which is then recorded in the HDD 18 is compressed using MPEG-4.

In step S1, the CPU 11 reads the image data recorded in the HDD 18 to extract a current macroblock from the current image data, and calculates the sum Σc(i,j) of the pixel values of the current macroblock.

In step S2, the CPU 11 extracts an initial reference macroblock with respect to the current image, and calculates the sum Σr(i,j) of the pixel values of the reference macroblock.

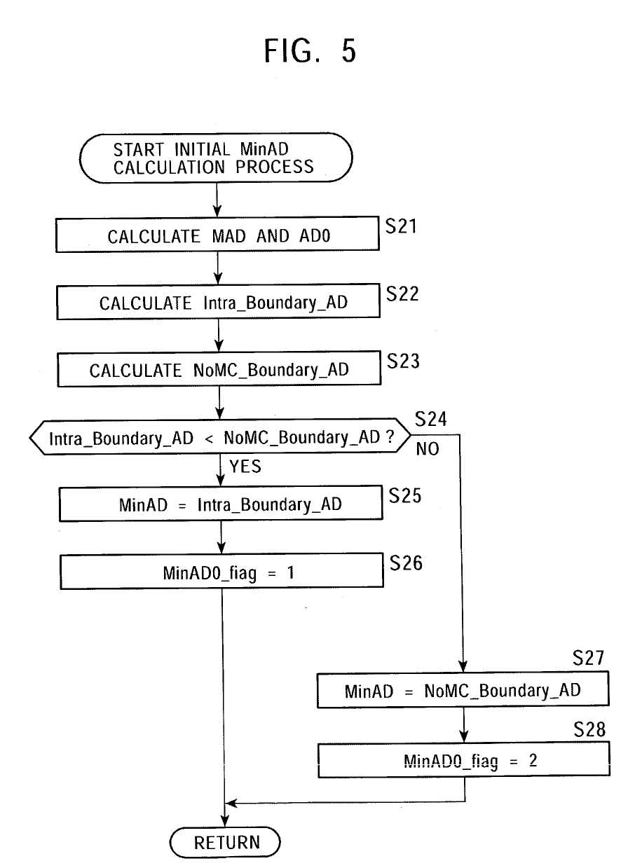

In step S3, a process for calculating the initial value of the minimum sum of absolute differences MinAD, as described below with reference to FIG. 5, is performed.

In step S4, the CPU 11 determines whether or not the above-noted expression (3) holds true using the presently minimum sum of absolute differences MinAD, the sum Σc(i,j) of the pixel values of the current macroblock determined in step S1, and the sum Σr(i,j) of the pixel values of the reference macroblock determined in step S2 or in step S9 described below.

If it is determined in step S4 that the above-noted expression (3) does not hold true, the process routine proceeds to step S8.

If it is determined in step S4 that the above-noted expression (3) holds true, then, in step S5, the CPU 11 calculates the sum of absolute differences AD between pixel values in the current macroblock and the present reference macroblock using the above-noted equation (1).

In step S6, the CPU 11 compares the sum of absolute differences AD determined in step S5 with the presently minimum sum of absolute differences MinAD to determine whether or not AD<MinAD holds true.

If it is determined in step S6 that AD<MinAD does not hold true, the process routine proceeds to step S8.

If it is determined in step S6 that AD<MinAD holds true, then, in step S7, the CPU 11 sets the value of the sum of absolute differences AD determined in step S5 as the presently minimum sum of absolute differences MinAD.

If it is determined in step S4 that the above-noted expression (3) does not hold true of if it is determined in step S6 that AD<MinAD does not hold true, or after step S7, the CPU 11 determines in step S8 whether or not all blocks of the search area have been searched.

If it is determined in step S8 that all blocks of the search area have not been searched, then, in step S9, the CPU 11 changes the search target, and calculates the sum Σr(i,j) of the pixel values of a new reference macroblock. The process routine then returns to step S4 to repeat the subsequent steps.

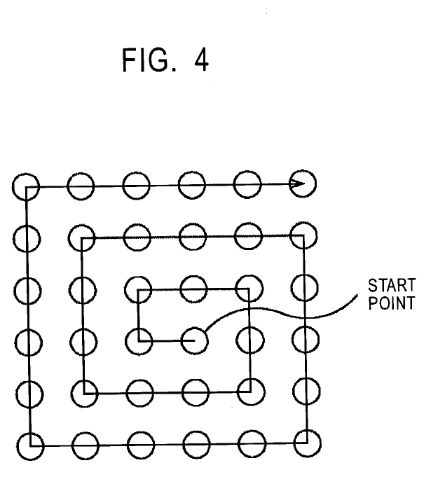

In step S9, the search target is changed in, for example, a spiral manner around the center starting from the position corresponding to the current macroblock, as shown in FIG. 4. In an actual moving picture, a number of macroblocks probably have a small motion vector in each scene. Thus, a spiral search shown in FIG. 4 is performed on the reference macroblocks, thus allowing the desired minimum sum of absolute differences MinAD to be found in an early search stage to possibly omit the processing of steps S5 through S7. Since the search target is spirally changed, a smaller vector can be selected as the desired motion vector when some identical minimum sums of absolute difference MinAD are present.

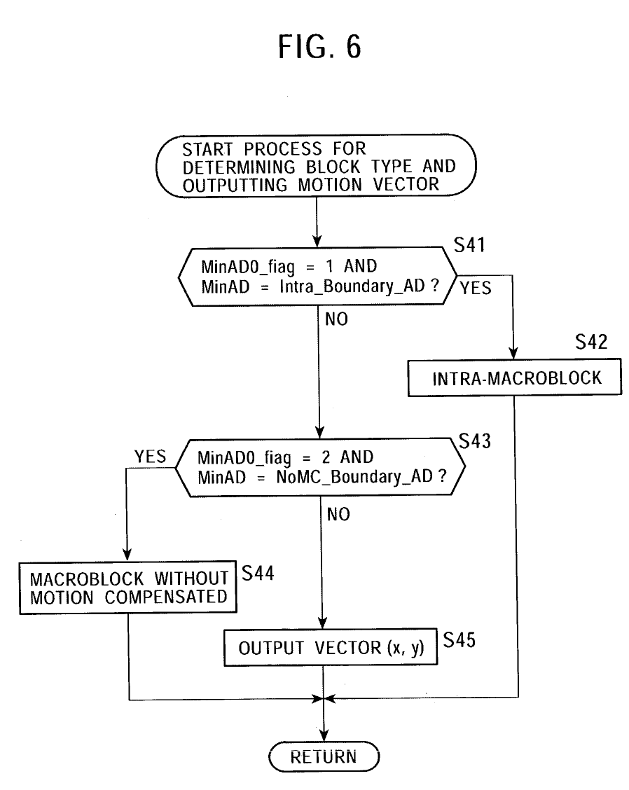

If it is determined in step S8 that all blocks of the search area have been searched, then, in step S10, a process for determining the block type and for outputting the motion vector, as described below with reference to FIG. 6, is performed. Then, the process routine ends.

The above-described processing enables the amount of computation needed for the motion search process to be reduced.

In step S9, there is no need for summing all the pixel values of a new 16×16 pixel reference macroblock in order to determine the sum Σr(i,j) of the pixel values of the new reference macroblock. It is only required to perform addition and subtraction on the pixel value of a pixel which does not belong to the previous reference macroblock.

For example, if the reference macroblock to be searched is shifted one line (16 pixels) in the horizontal or vertical direction, the pixel values of 16 pixels which do not belong to a next reference macroblock are subtracted from the sum Σr(i,j) of the pixel values of the previous reference macroblock, and the pixel values of 16 pixels which belong to the next reference macroblock are added to the sum Σr(i,j) of the pixel values of the previous reference macroblock. Assuming that a spiral search shown in FIG. 4 is performed on the reference macroblocks, then, in step S9, the pixel values of 16 pixels are subtracted and the pixel values of 16 pixels are added.

The process for calculating the initial value of the minimum sum of absolute differences MinAD performed in step S3 of the flowchart shown in FIG. 3 is now described with reference to the flowchart of FIG. 5.

In step S21, the CPU 11 calculates the sum of absolute differences between the mean pixel value and each pixel of a macroblock, as indicated by MAD, and the sum of absolute differences when the motion vector is zero, as indicated by AD0.

In step S22, the CPU 11 uses the value MAD determined in step S21 to calculate threshold Intra_Boundary_AD for determining whether the macroblock is an intra-macroblock or an inter-macroblock.

When the minimum sum of absolute differences MinAD is greater than or equal to the threshold Intra_Boundary_AD, the macroblock is an intra-macroblock. The intra-macroblock refers to a macroblock of a new image having no reference image. Since information is not obtained from a reference image, the intra-macroblock is encoded without motion vector coding by referring to an adjacent block to perform AC/DC prediction and DCT. If the minimum sum of absolute differences MinAD is smaller than the threshold Intra_Boundary_AD, on the other hand, the macroblock is an inter-macroblock. The inter-macroblock is encoded based on a reference image by performing motion compensation based on a motion vector, and DCT.

In step S23, the CPU 11 uses the sum of absolute differences AD0 determined in step S21 to calculate threshold NoMC_Boundary_AD for determining whether or not motion vector is set to zero, in other words, for determining whether or not motion compensation is applied.

The threshold NoMC_Boundary_AD is used to prevent noise detected as motion vector in a scene in which no movement is included in an actual image. When the minimum sum of absolute differences MinAD is greater than or equal to the threshold NoMC_Boundary_AD, the resulting motion vector is not used but the motion vector is set to zero to perform the processing.

In step S24, the CPU 11 compares the threshold Intra_Boundary_AD determined in step S22 with the threshold NoMC_Boundary_AD determined in step S23 to determine whether or not Intra_Boundary_AD<NoMC_Boundary_AD holds true.

If it is determined in step S24 that Intra_Boundary_AD <NoMC_Boundary_AD holds true, then, in step S25, the CPU 11 sets the initial value of the minimum sum of absolute differences MinAD to the value of the threshold Intra_Boundary_AD determined in step S22. Then, in step S26, the value of MinAD0_fiag is set to 1. These values are stored in the RAM 16, and the process routine returns to step S4 of the flowchart shown in FIG. 3.

If it is determined in step S24 that Intra_Boundary_AD<NoMC_Boundary_AD does not hold true, then, in step S27, the CPU 11 sets the initial value of the minimum sum of absolute differences MinAD to the value of the threshold NoMC_Boundary_AD determined in step S23. Then, in step S28, the value of MinAD0_fiag is set to 2. These values are stored in the RAM 16, and the process routine returns to step S4 of the flowchart shown in FIG. 3.

In effect, the value of the threshold NoMC_Boundary_AD determined based on the sum of absolute differences AD0 is smaller than or equal to the sum of absolute differences AD0. Therefore, smaller one of the threshold Intra_Boundary_AD and the threshold NoMC_Boundary_AD is necessarily smaller than or equal to the sum of absolute differences AD0. The processing discussed above with reference to FIG. 5 enables the value of the minimum sum of absolute differences MinAD AD to be set to a small value. In the motion search process discussed above with reference to FIG. 3, the matching process of a macroblock determined as an intra-macroblock or as a macroblock without motion compensation, i.e., the processing of steps S5 through S7, is omitted, thus reducing the amount of computation.

The process for determining the block type and for outputting the motion vector performed in step S10 of the flowchart shown in FIG. 3 is now described with reference to the flowchart of FIG. 6.

In step S41, the CPU 11 checks the value of MinAD0_fiag and the value of the minimum sum of absolute differences MinAD stored in the RAM 16 to determine whether or not MinAD0_fiag=1 is satisfied, that is, whether or not the initial value of the minimum sum of absolute differences MinAD is equal to Intra_Boundary_AD, and whether or not the value of the minimum sum of absolute differences MinAD after all blocks of the search area have been searched is equal to Intra_Boundary_AD.

If it is determined in step S41 that both MinAD0_fiag=1 and MinAD=Intra_Boundary_AD are satisfied, then, in step S42, the CPU 11 determines that the processed macroblock is an intra-macroblock having no other reference image. Then, the process routine ends.

If it is determined in step S41 that MinAD0_fiag=1 and MinAD=Intra_Boundary_AD are not satisfied, then, in step S43, the CPU 11 checks the value of MinAD0_fiag and the value of the minimum sum of absolute differences MinAD stored in the RAM 16 to determine whether or not MinAD0_fiag=2 is satisfied, that is, whether or not the initial value of the minimum sum of absolute differences MinAD is equal to NoMC_Boundary_AD, and whether or not the value of the minimum sum of absolute differences MinAD after all blocks of the search area have been searched is equal to NoMC_Boundary_AD.

If it is determined in step S43 that both MinAD0_fiag=2 and MinAD=NoMC_Boundary_AD are satisfied, then, in step S44, the CPU 11 determines that the processed macroblock is a macroblock without motion compensated. Then, the process routine ends.

If it is determined in step S43 that MinAD0_fiag=2 and MinAD=NoMC_Boundary_AD are not satisfied, the processed macroblock is an inter-macroblock to be encoded using a reference image, and a macroblock with motion compensated. Then, in step S45, the CPU 11 determines motion vector MV(x,y) based on the amount of movement from the current macroblock to the reference macroblock which gives the minimum sum of absolute differences MinAD, and outputs the resulting value. Then, the process routine ends.

The macroblock type or motion vector determined in the above-described processing is used to encode the macroblock (these results are output for encoding the subsequent macroblock).

Assuming that a 16×16 pixel macroblock is used and a motion vector in a search area of S×S macroblocks is determined, the amount of computation needed for a typical calculation method is compared with the amount of computation needed for a calculation method according to the present invention.

When the typical calculation method is used to determine the sum of absolute differences AD between macroblocks in a current image and a reference image, the pixel-by-pixel differences are taken between the 256 pixels of the current macroblock and the 256 pixels of the reference macroblock to obtain the absolute values of the resulting 256 values which are then summed. It is further necessary to perform the above-noted calculation on all the search area of S×S macroblocks in order to determine the motion vector. The amount of computation T1 needed for the typical calculation method is therefore given by the following equation (4):

$$T1 = ( 256 \text{<subtraction>} + 256 \text{<absolute value calculation>} + 256 \text{<addition>} ) \times S \times S \qquad ( 4 )$$

In the calculation method according to the present invention, in contrast, first, the pixel values of the 256 pixels of a macroblock in the current image are summed in step S1 before determining the sum of absolute differences AD, and then, in step S2, the pixel values of the 256 pixels of a macroblock in a first reference image are summed. The processing of step S4 is then performed on all the macroblocks (S×S macroblocks) of the search area. In other words, S×S computations each consisting of one subtraction, one absolute value calculation, and one comparison calculation are performed.

Based on the comparison result of step S4, the sum of absolute differences AD is determined in step S5. As discussed above, this processing requires for taking the pixel-by-pixel differences between the 256 pixels of the current macroblock and the 256 pixels of the reference macroblock to obtain the absolute values of the resulting 256 values which are then summed. It is assumed that it is determined in step S4 that the above-noted expression (3) holds true, and that the number of computations performed in step S5 is designated by “a” (0<a<S×S).

Until it is determined in step S8 that all the blocks of the search area have been searched, S×S computations are performed in step S9 to subtract and add the 16 pixels which do not belong to the previous reference macroblock in order to determine the sum Σr(i,j) of the pixel values of the next reference macroblock.

Therefore, the amount of computation T2 needed for the calculation method according to the present invention is given by the following equation (5):

$$T2 = 256 \text{<addition>} + 256 \text{<addition>} + ( 1 \text{<subtraction>} + 1 \text{<absolute value calculation>} + 1 \text{<comparison calculation>} + 16 \text{<addition>} + 16 \text{<subtraction>} ) \times S \times S + ( 256 \text{<subtraction>} + 256 \text{<absolute value calculation>} + 256 \text{<addition>} ) \times a \qquad ( 5 )$$

If the amount T2 given by equation (5) is smaller than the amount T1 given by equation (4), it is proved that the number of computations needed for the motion search process according to the present invention is smaller than the number of computations needed for the typical method. According to the present invention, as discussed above with reference to FIG. 4, a spiral search is performed on the reference macroblocks, and, as discussed above with reference to the flowchart shown in FIG. 5, the initial value of the minimum sum of absolute differences MinAD is set to a value as small as possible, thus allowing the number of computations performed in step S5 of the flowchart shown in FIG. 3, that is, the value of “a” given in equation (5), to be significantly reduced. Therefore, the number of computations needed for the motion search process according to the present invention can be smaller than the number of computations needed for the typical method.

In the present invention, the initial value of the minimum sum of absolute differences MinAD is set to a small value, and a spiral search is performed on the reference macroblocks with respect to the current macroblock, thereby obtaining the desired minimum sum of absolute differences MinAD at an early stage and reducing the number of computations performed by matching between the current macroblock and the reference macroblock, depending upon the content of an image to be compressed. The present invention is advantageous, in particular, for reducing the number of computations needed for motion search in a wide search area.

Although the illustrated embodiment has been discussed in the context of moving image data compressed using MPEG-4, the present invention is not limited to image compression using MPEG-4, and encompasses image compression using any MPEG technique.

The above-described processing is performed by a personal computer; however, the present invention is applicable to any image processing device including a PDA, a portable telephone set, and an image recording/playback apparatus.

The above-described processing may be implemented by software. In this case, software implementing the above-described processing can be installed from a recording medium to a computer incorporating a program constructing the software in a dedicated hardware or a device, such as a general-purpose personal computer, capable of achieving various functions by installing various programs.

The recording medium is separate from the computer and is distributed to provide a user for the program. The recording medium may be implemented by packaged media having the program recorded therein, such as the magnetic disk 21 (including a flexible disk), optical disk 22 (including a CD-ROM and a DVD (digital versatile disk)), magneto-optical disk 23 (including an MD (Mini-Disk)(trademark)), and semiconductor memory 24 shown in FIG. 1.

It is to be understood herein that the steps describing a program recorded in a recording medium include steps performed in a time-series manner according to the described order, and steps performed in a parallel or discrete manner although the steps are not necessarily performed in a times-series manner.

What is claimed is:

1. An information processing apparatus for compressing image data using an MPEG (Moving Picture Expert Group) technique, the apparatus comprising:
extracting means for extracting at least one second block, the second block being a reference block with respect to a first block formed of a predetermined number of pixels in the image data;
first calculating means for calculating a first value which is the absolute difference between the sum of the pixels of the first block and the sum of the pixels of the second block extracted by the extracting means;
first setting means for setting the initial value of a second value which is compared to the first value determined by the first calculating means;
first comparing means for comparing the first value determined by the first calculating means with the second value;
second calculating means for calculating a third value which is the sum of absolute differences between the pixels of the first block and the pixels of the second block when it is determined by the first comparing means that the first value is smaller than the second value; and
second setting means for setting the third value as the second value when the third value determined by the second calculating means is smaller than the second value,
wherein the extracting means sequentially extracts all the second blocks in a predetermined search area.

2. An information processing apparatus according to claim 1, wherein the extracting means moves the extracted target in the second blocks within the search area in a spiral manner around the first block.

3. An information processing apparatus according to claim 1, wherein the first setting means sets the initial value of the second value to smaller one of a first threshold for determining whether or not motion compensation is performed and a second threshold for determining whether or not the first block contains a reference block.

4. An information processing apparatus according to claim 1, further comprising output means for outputting a result of determination of the block type of the first block using the second value after processing performed on all the second blocks extracted by the extracting means is completed, or a result of calculation of a motion vector used to encode the first block.

5. An information processing method of compressing image data using an MPEG (Moving Picture Expert Group) technique, the method comprising:
an extracting step of extracting at least one second block, the second block being a reference block with respect to a first block formed of a predetermined number of pixels in the image data;
a first calculating step of calculating a first value which is the absolute difference between the sum of the pixels of the first block and the sum of the pixels of the second block extracted in the extracting step;
a first setting step of setting the initial value of a second value which is compared to the first value determined in the first calculating step;
a first comparing step of comparing the first value determined in the first calculating step with the second value;
a second calculating step of calculating a third value which is the sum of absolute differences between the pixels of the first block and the pixels of the second block when it is determined in the first comparing step that the first value is smaller than the second value; and
a second setting step of setting the third value as the second value when the third value determined in the second calculating step is smaller than the second value,
wherein, in the extracting step, all the second blocks in a predetermined search area are sequentially extracted.

6. A recording medium containing a computer-readable program for an information processing apparatus for compressing image data using an MPEG (Moving Picture Expert Group) technique, the program comprising:
an extracting step of extracting at least one second block, the second block being a reference block with respect to a first block formed of a predetermined number of pixels in the image data;
a first calculating step of calculating a first value which is the absolute difference between the sum of the pixels of the first block and the sum of the pixels of the second block extracted in the extracting step;
a first setting step of setting the initial value of a second value which is compared to the first value determined in the first calculating step;
a first comparing step of comparing the first value determined in the first calculating step with the second value;
a second calculating step of calculating a third value which is the sum of absolute differences between the pixels of the first block and the pixels of the second block when it is determined in the first comparing step that the first value is smaller than the second value; and
a second setting step of setting the third value as the second value when the third value determined in the second calculating step is smaller than the second value,
wherein, in the extracting step, all the second blocks in a predetermined search area are sequentially extracted.

7. A program executable by a computer for controlling an information processing apparatus for compressing image data using an MPEG (Moving Picture Expert Group) technique, the program comprising:
an extracting step of extracting at least one second block, the second block being a reference block with respect to a first block formed of a predetermined number of pixels in the image data;
a first calculating step of calculating a first value which is the absolute difference between the sum of the pixels of the first block and the sum of the pixels of the second block extracted in the extracting step;
a first setting step of setting the initial value of a second value which is compared to the first value determined in the first calculating step;
a first comparing step of comparing the first value determined in the first calculating step with the second value;
a second calculating step of calculating a third value which is the sum of absolute differences between the pixels of the first block and the pixels of the second block when it is determined in the first comparing step that the first value is smaller than the second value; and
a second setting step of setting the third value as the second value when the third value determined in the second calculating step is smaller than the second value,
wherein, in the extracting step, all the second blocks in a predetermined search area are sequentially extracted.
